(19) United States
(12) Patent Application Publication
(10) Pub. No.: US 2025/0002114 A1
(43) Pub. Date: Jan. 2, 2025

(54) ADJUSTABLE BIKE

(71) Applicant: Asgeir MATTHIASSON, Reykjavik (IS)

(72) Inventor: Asgeir MATTHIASSON, Reykjavik (IS)

(21) Appl. No.: 18/710,280

(22) PCT Filed: Nov. 15, 2022
(86) PCT No.: PCT/IS2022/050008

§ 371 Date: May 15, 2024

(30) Foreign Application Priority Data
Nov. 15, 2021 (IS) 050349

(51) Int. Cl. B62M 6/65; B62J 1/08; B62J 1/28; B62J 43/13; B62J 45/20; B62K 3/02; B62K 23/06; B62M 3/02; B62M 6/90

(52) U.S. Cl. CPC B62M 6/65; B62J 1/08; B62J 1/28; B62J 43/13; B62J 45/20; B62K 3/02; B62K 23/06; B62M 3/02; B62M 6/90; B62K 2204/00

(57) ABSTRACT

An electrical bicycle designed to be adaptable to the cyclist, wherein the position of one or more of the components of the bike are adjustable, including the position of the handle, the saddle and the pedals.

### FIELD OF THE INVENTION

The present invention relates to an adjustable electric bicycle which can be adjusted to be operated in multiple positions.

### INTRODUCTION

Bicycles have been a part of our communication system for a long time. Their origins can be traced back to the middle of the 19th century and today it is estimated that about 1 trillion bicycles exist now, which is far more than traditional cars in the world today. Recently, the popularity of bicycle has vastly increased, both for outdoor activities and as an environmentally friendly mode of transportation. The vast majority of bicycles are traditional two-wheelers where the cyclist sits on the bike seat, the saddle, and pushes down on the pedals with each foot rotating a chain which rotates the back wheel. The arm of the pedals is a fixed size and the necessary torque to propel the wheel is obtained with the stepping force with which the pedal is driven. Most modern wheels are equipped with gears so that the load can be changed with a variable gear ratio.

In recent years, electrical bicycles have been developed and have become very popular. These bicycles are traditional bikes with a chain and pedals, but they are also equipped with an electrical motor and battery for assisting with rotation of the rear wheel. The assistance of the motor can be adjusted by the biker, so that the biker can select the amount of assistance required at any time of the bike ride.

The construction and design of traditional bicycles has largely been successful and the vast majority of those who are healthy can easily adapt to the position required by the bike so that they maintain balance and can propel the bike. On the other hand, there is a large group who find it difficult to use bicycles for outdoor activities or as a means of transport because it requires a load that this group has difficulty carrying. These are primarily people with back injuries that are a very large group as well as older people who have difficulty balancing when people start or stop. Research has shown that it is in these circumstances that most cycling accidents occur in that age group. For those with back and knee injuries, the problem is how inflexible the bike is, the cyclist is locked in the same position to be able to propel the bike forward and it causes abnormal strain on the back and knees. For older cyclists the balance is the main problem because when starting out, the cyclist has to lift both feet off the ground and move them up on the pedals to propel the bike and this requires a lot of motor skills that older people are starting to lose. The same can be said for stopping the bike, as the cyclist has to step off the saddle and put your feet on the ground and it can be difficult.

Therefore, it is important to accommodate this group and redesign the bicycle and adapt to overcome the shortcomings of present bikes to enable more people to use bike for transport, exercise and leisure.

### SUMMARY OF THE INVENTION

The present invention relates to adjustable bikes where the position of one or more of the components of the bike are adjustable, to alter the position of the handlebar, the saddle, and the pedal unit relative to the cyclist. The bike of the present invention may comprise one or more adjusting mechanisms for altering the position of the handlebar, the saddle, and the pedal unit before, during and after a bike ride based on different moments of the ride. The adjusting mechanisms may be manually controlled by the cyclist or programmed to be operated by a computing device and a software, such as an app on a smart phone.

An electrically motorized vehicle is presented herein providing a bicycle designed to be adapted to the cyclist, where the position of one or more of the components of the bike are adjustable, including the position of the handlebar, the saddle, and the pedal unit. This may be advantageous for people who have any problems with manoeuvring traditional bikes due to age and/or disability etc. The present invention provides an electrical bicycle with increased flexibility for the cyclist so that the bike can be adapted to the cyclist himself instead of having the cyclist having to adapt to the bike. The bicycle of the present invention allows the cyclist to change the position of the pedals on the bike and thereby changing the angle of attack and the position of the cyclist relative to the pedals. In this way, the cyclist can choose whether the legs are close to a vertical angle to the body if sitting straight or whether they are at an angle of up to 120° with respect to the seat in order to change the strain on the body. Furthermore, an increased flexibility with respect to the position of the seat and the handlebar during different time points in the bike ride are desirable.

The present invention provides an electrical bike where the connection between the drive devices on the bike, i.e. the pedals and the chain in connection with the rear wheel on traditional bikes, are disconnected and the driving force for the rear wheels is provided by a motor and a generator instead of a chain and a cogwheel. The power transmission is arranged by a generator in the hub of the pedals, which by rotating the pedals produces electricity instead of mechanical power. In addition, the bicycle of the present invention is equipped with a battery and an electric motor in the hub of the rear wheel for rotating the rear wheel. By rotating the pedals, electricity is charged to the battery and that electricity is used to power the electric motor mounted on the rear wheel. The bike of the present invention may also be provided with a charger to charge the battery prior to a bike ride, but the generator provides charging of the battery during the bike ride. In this way it is possible to move the pedals back and forth in a specially made lane on the frame of the bicycle and in this way the bicycle is more flexible for the cyclist.

In some embodiments the position of the saddle is automatically or manually lowered when the bike slows down to stop it and keeping it in a low position when starting, but then the saddle is raised when a certain speed is reached, and it is easier to hold balance. In the same manner the position of the handlebar in relation to the biker at different stages of a bike ride. Furthermore, the position of the pedals may also be automatically or manually changed during different stages of a bike ride to provide a more suitable angle of attack for the biker at the different stages.

In some embodiments the adjustable components of the electrical bicycle are placed into a desired position at one or more stages of a bike ride by an adjustment mechanism for determining the position of components such as the steering rod, the handlebar, the pedals, the saddle, the saddle rod, and the backrest. These adjustment mechanism may comprise electrical or hydraulic joints, locks and adjustable bars which may be regulated or adjusted using a control unit or control mechanism such as an APP on a phone or levers/shifters in the handlebar or on the frame.

In some embodiments an electrical bike of the present invention comprises sensors or measuring devices such as, but not limited to, accelerometer, speed sensor, sensors for determining the position of the pedals and the rotation speed of the pedals, tilt sensor and gyro compass.

In some embodiments the frame of the bike of the present invention is lateral or diagonal based on design and expected use.

It is an object of the present invention to overcome and/or ameliorate the aforementioned drawbacks of the prior art and to provide an improved and/or alternative and/or additional electrical bike. It is one preferred object of the present invention to provide a device to facilitate an electrical bike with a generator associated with the pedals instead of a chain and a cogwheel for charging a battery. Moreover, it is a preferred object of the present invention to provide an adjustable position of the pedals on the frame, adjustable position of the saddle with respect to the front and back as well as to the height from the ground, and adjustable position of the steer. Another preferred object of the present invention is to provide a bike where the position of the pedals, steer and saddle may be changed during a bike ride and for setting personal settings for different users. Another preferred object of the present invention is to provide a bike where the position of the pedals, steer and saddle may be adjusted using a control devices and optionally an APP on a computing device or a mobile phone.

The object(s) underlying the present invention is (are) particularly solved by the features defined in the independent claims. The dependent claims relate to preferred embodiments of the present invention. Further additional and/or alternative aspects are discussed below.

It is an object of the present invention to provide an electrical bike wherein a pedal unit is connected to a generator to charge electricity to a battery, and wherein the pedal unit is movably arranged on the frame to alter the longitudinal position of the pedal unit.

It is another object of the present invention to provide an electric bike comprising a frame, a front wheel, a front wheel fork, a rear wheel, a steering rod with a handlebar, a saddle, a pedal unit, a generator, and a battery, where the pedal unit is connected to the generator and, and wherein the pedal unit is movably arranged on the frame to alter the longitudinal position of the pedal unit.

Another object of the present invention provides a system for operating an electric bike comprising providing i) one or more pedal unit adjusting mechanism, ii) one or more handlebar adjusting mechanism, and iii) one or more saddle adjusting mechanism, wherein the position of one or more of the handlebar, the saddle, and the pedal unit may be adjusted before and/or during a bike ride.

Another object of the present invention provides a system for operating an electric bike where the bike comprises a frame, a front wheel, a front wheel fork, a rear wheel, a steering rod, a handlebar, a saddle, a pedal unit, a generator, a motor and a battery, wherein the electric bike further comprises i) one or more motorized pedal unit adjusting mechanism, ii) one or more motorized handlebar adjusting mechanism, and iii) one or more motorized saddle adjusting mechanism, and wherein the position of one or more of the handlebar, the saddle, and the pedal unit, the position of one or more of the handlebar, the saddle, and the pedal unit may be adjusted after the start of a bike ride.

Another object of the present invention provides a bicycle comprising; a frame, a front wheel, a front wheel fork, a rear wheel, a steering rod, a handlebar, a saddle a frame, a pedal unit comprising a crank set, chain and chainrings, a generator, a motor and a battery, wherein the motor may assist the rotation of the rear wheel and wherein the pedal unit is connected to a generator to charge the battery.

It is an object of the present invention to provide an electric bike, the electric bike comprising; a frame, a front wheel, a front wheel fork, a rear wheel, a steering rod, a saddle, pedal unit, a generator, and a battery, where the pedals are connected to the generator and the pedal unit are adjustably arranged to the frame to determine the position of the pedal unit on the frame.

Another object of the present invention provides a system for operating an electric bike where one or more of; the adjustment joint, the steering rod adjustment mechanism, the pedals adjusting mechanism, the saddle rod adjustment mechanism, the saddle adjustment joint, the saddle rod attachment joint, and the backrest attachment joint further comprise an adjusting mechanism for a manual, mechanical or electronic adjustment of the saddle, and/or handlebar, and/or the pedals, and where the bike further comprises a device/mechanism for mechanical and/or electrical operation of the adjusting mechanism for the saddle, the steering rod and the pedals, either individually or combined.

In the present context the terms “bike”, “bicycle” and electric “bicycle” relate traditional bikes, hybrid bikes and electrical bikes. The electrical bikes may comprise electrical vehicles according to the present invention having an electrical motor connected to the rear wheel of the vehicle to power the riding of the vehicle.

In the present context the terms “biker”, “cyclist” and “operator” all relate to the person riding the vehicle of the present invention

In an embodiment of the present invention the bike is a traditional bicycle or an electric bike or a hybrid bike where a motor may assist the cyclist although the bike is mechanically driven by pushing pedals on pedal unit comprising cranks, pedals, a chain and chainwheels.

In an embodiment of the present invention the bike comprises a frame, a front wheel, a front wheel fork, a rear wheel, a steering rod, a handlebar, a saddle, and a pedal unit.

In an embodiment of the present invention the bike further comprises a generator, a motor, and a battery.

In an embodiment of the present invention the steering rod further comprises a handlebar.

In an embodiment of the present invention the steering rod is connected to an adjustment joint to determine the position of the handlebar in relation to the cyclist.

In an embodiment of the present invention the adjustment joint further comprises a control mechanism for a manual, mechanical or electronic adjustment of position of the steering rod.

In an embodiment of the present invention the steering rod further comprises a steering rod adjustment mechanism for adjusting the length of the steering rod.

In an embodiment of the present invention the steering rod and the handlebar are formed as one piece.

In an embodiment of the present invention the handlebar is connected to the steering rod through a stem.

In an embodiment of the present invention the bike further comprises an angle adjustment joint in the frame to alter the angle of the steering rod and thereby the alignment of the handlebar relative to the cyclist.

In an embodiment of the present invention the bike comprises a pedal unit adjusting mechanism for adjusting the position of the pedal unit on the bike.

In an embodiment of the present invention the pedal unit adjusting mechanism is arranged within in the frame of the electric bike.

In an embodiment of the present invention pedal unit adjusting mechanism is an elongated slit in the frame for sliding the pedals back and forth between the front and back of the frame.

In an embodiment of the present invention the pedal unit is movably arranged on the frame to alter the longitudinal position of the pedal unit.

In an embodiment of the present invention the pedal unit adjusting mechanism is arranged on the exterior of the frame.

In an embodiment of the present invention the pedal unit adjusting mechanism comprises means to alter the longitudinal position of the pedal unit on the exterior of the frame.

In an embodiment of the present invention the pedal unit adjusting mechanism allows a manual, mechanical or electronic adjustment of the pedal unit.

In an embodiment of the present invention the saddle is mounted on the frame through a saddle rod.

In an embodiment of the present invention the position of the saddle is adjusted through a saddle rod adjustment mechanism which allows adjustment of the saddle in the directions up and down from the frame or in relation to direction of seat pipe.

In an embodiment of the present invention the position of the saddle is further adjusted through a saddle adjustment joint, which allows a seesaw adjustment of the saddle relative to the top of the saddle rod.

In an embodiment of the present invention the saddle rod is arranged in a seat tube, where the seat tube is attached to the frame through a saddle rod attachment joint for adjustment of the angle of the saddle rod in a longitudinal direction.

In an embodiment of the present invention the saddle rod attachment joint allows adjustment of the angle of the seat tube on the frame.

In an embodiment of the present invention the saddle has a backrest.

In an embodiment of the present invention the saddle and the backrest are connected through a backrest adjustment joint for adjusting the position of the backrest and the alignment of the backrest relative to the saddle.

In an embodiment of the present invention the bike further comprises a saddle sliding mechanism for adjusting the longitudinal position of the saddle along the frame of the bike.

In an embodiment of the present invention the one or more saddle adjustment mechanism further comprises a control mechanism for a manual, mechanical or electronic adjustment of the saddle.

In an embodiment of the present invention a part of the frame or the whole frame is assembled from one or more plates and or profiles to form a hollow frame.

In an embodiment of the present invention the hollow frame is assembled to from tubes and profiles.

In an embodiment of the present invention the hollow frame is assembled to house one or more adjustment mechanism.

In an embodiment of the present invention the hollow frame comprises means for at least partially open the hollow frame for maintenance of components housed within the frame.

In an embodiment of the present invention the frame comprises two profiles which are fixed together during assembly.

In an embodiment of the present invention the frame comprises a seat tube.

In an embodiment of the present invention the seat tube comprises a saddle rod.

In an embodiment of the present invention the saddle rod is arranged in the seat tube.

In an embodiment of the present invention the frame comprises a head tube.

In an embodiment of the present invention the head tube comprises a steering rod.

In an embodiment of the present invention the steering rod adjustment mechanism is arranged in the head tube.

In an embodiment of the present invention the frame at least part of the frame comprises two profiles.

In an embodiment of the present invention the two profiles are fixed together during assembly.

In an embodiment of the present invention the two profiles form the sides of the frame.

In an embodiment of the present invention the two profiles forming the sides of the frame are connected on the top and on the bottom by a top and a bottom plate to form a closed hollow frame.

In an embodiment of the present invention the closed hollow frame formed by the two profiles and the top and bottom plate may house one or more adjustment mechanism.

In an embodiment of the present invention the closed hollow frame may be assembled by fastening means which allow the frame to be at least partially opened for maintenance of one or more adjustment mechanism.

In an embodiment of the present invention the head tube is arranged in the frame between the two profiles.

In an embodiment of the present invention the seat tube is arranged in the frame between the two profiles.

In an embodiment of the present invention the adjustment joint is arranged in the frame between the two profiles.

In an embodiment of the present invention the bike comprises one or more pedal unit adjusting mechanism.

In an embodiment of the present invention the bike comprises one or more handlebar adjusting mechanism.

In an embodiment of the present invention the bike comprises one or more saddle adjusting mechanism.

In an embodiment of the present invention the one or more saddle adjusting mechanism comprises one or more a saddle rod adjustment mechanism, a saddle adjustment joint, a saddle rod attachment joint, a saddle sliding mechanism and a backrest attachment joint.

In an embodiment of the present invention the one or more handlebar adjusting mechanism comprises an angle adjustment joint for adjusting the angle of the steering rod and/or a steering rod adjustment mechanism to adjust the length of the steering rod.

In an embodiment of the present invention the one or more pedal unit adjusting mechanism, ii) one or more handlebar adjusting mechanism, and iii) one or more saddle adjusting mechanism may comprise a motorized adjusting mechanism.

In an embodiment of the present invention the one or more saddle adjusting mechanism

In an embodiment of the present invention the motorized adjusting mechanism may comprise a hydraulic mechanism or an electrical actuator mechanism.

In an embodiment of the present invention the motorized adjusting mechanism may comprise electrical joints, hydraulic joints, locks, and adjustable bars.

In an embodiment of the present invention the saddle rod adjustment mechanism and/or the saddle adjustment joint is/are arranged in the frame between the two profiles of the frame.

In an embodiment of the present invention the saddle rod attachment joint is arranged in the frame between the two profiles.

In an embodiment of the present invention the bike further comprises a motor.

In an embodiment of the present invention the motor is arranged in the a of the rear wheel for rotating the rear wheel.

In an embodiment of the present invention the motor is an electric motor.

In an embodiment of the present invention the bike further comprises a battery.

In an embodiment of the present invention the bike further comprises a generator.

In an embodiment of the present invention the generator is arranged in a hub of the pedal unit.

In an embodiment of the present invention the generator is a magnetic field type generator, such as variable or adjustable magnetic field type generator.

In an embodiment of the present invention resistance on the pedals can be adjusted such that increased resistance generates faster charging of the battery by the generator.

In an embodiment of the present invention the generator is connected to the battery to store electrical energy generated by rotation of the pedals.

In an embodiment of the present invention a charger may be connected to charge the battery prior to a bike ride.

In an embodiment of the present invention one or more of i) the adjustment joint, ii) the steering rod and adjustment mechanism, iii) the pedal unit adjusting mechanism, iv) the saddle rod adjustment mechanism, v) the saddle adjustment joint, vi) the saddle rod attachment joint, vii) a saddle sliding mechanism, and viii) the backrest attachment joint are referred to as the adjusting mechanisms for the position of the saddle, the handlebar and the pedal unit in relation to the cyclist.

In an embodiment of the present invention the adjusting mechanisms for the position of the saddle, the handlebar and the pedal unit in relation to the operator may be manual, mechanical or electronic adjustment mechanism.

In an embodiment of the present invention the bike further comprises a control unit for the adjusting mechanisms for the saddle, the handlebar and the pedal unit.

In an embodiment of the present invention each adjusting mechanism may be controlled either individually or combined with others for determining the position of the saddle, the handlebar and the pedal unit in relation to the operator for one or more moments of a bike ride.

In an embodiment of the present invention the one or more pedal unit adjusting mechanism, ii) one or more handlebar adjusting mechanism, and iii) one or more saddle adjusting mechanism may alter the bike configuration based on the speed of the bike during a bike ride.

In an embodiment of the present invention the bike comprises one or more of the following adjusting mechanisms: i) a pedal unit adjusting mechanism, ii) an angle adjustment joint, iii) a steering rod adjustment mechanism, iv) a saddle rod adjustment mechanism, v) a saddle adjustment joint, vi) a saddle rod attachment joint, vii) a backrest adjusting joint, and viii) a mechanism for adjusting the longitudinal position of the saddle, where each of the one or more adjusting mechanisms comprises means for operating the one or more adjusting mechanisms to determine a position of one or more of pedal unit, handlebar and pedals.

bike part (define)) define that the one or more adjusting mechanisms (to determine a position of one or more of pedal unit, handlebar and pedals although other bike parts are involved

In an embodiment of the present invention the means for operating the one or more adjusting mechanisms comprises manual means to determine the position of one or more bike parts.

In an embodiment of the present invention the means for operating the one or more adjusting mechanisms comprises mechanical and/or electronic means to determine the position of one or more bike parts.

In an embodiment of the present invention the means for operating the one or more adjusting mechanisms are operated by the cyclist through leavers in the handlebar or on the frame.

In an embodiment of the present invention the bike further comprises a control unit for mediating the mechanical and/or electrical operation of the adjusting mechanisms.

In an embodiment of the present invention the control unit is positioned on the handlebar or on the frame, and wherein the control unit has an interface for cyclist to operate the control unit.

In an embodiment of the present invention the control unit is operated through an application (APP) on a computing device or by the cyclist through leavers in the handlebar or on the frame.

In an embodiment of the present invention the control unit may be programmed to have stored in a memory more than one set of settings to determine the position of handlebar, the saddle, and the pedal unit for one or more users.

In an embodiment of the present invention the control unit may be programmed to have stored in a memory more than one set of settings to determine the position of handlebar, the saddle, and the pedal unit for one or more moments of a bike ride.

### BRIEF DESCRIPTION OF THE DRAWINGS

The skilled person will understand that the drawings, described below, are for illustration purposes only. The drawings are not intended to limit the scope of the present teachings in any way.

FIG. 1 is a side (A) and a top (B) view of an electric bicycle according to one embodiment of the present invention indicating the different components of the bike.

FIG. 2 is a side view of the electric bicycle in FIG. 1 indicating different adjustment mechanisms.

FIG. 3 is a side view of an electric bicycle according to a second embodiment of the present invention indicating the different components of the bike.

FIG. 4 is a side view of the electric bicycle in FIG. 3 indicating different adjustment mechanisms.

FIG. 5 shows an assembly of the electric bicycle in FIG. 1.

### DETAILED DESCRIPTION OF THE PREFERRED EMBODIMENTS

In the following, exemplary embodiments of the invention will be described, referring to the figures. These examples are provided to provide further understanding of the invention, without limiting its scope.

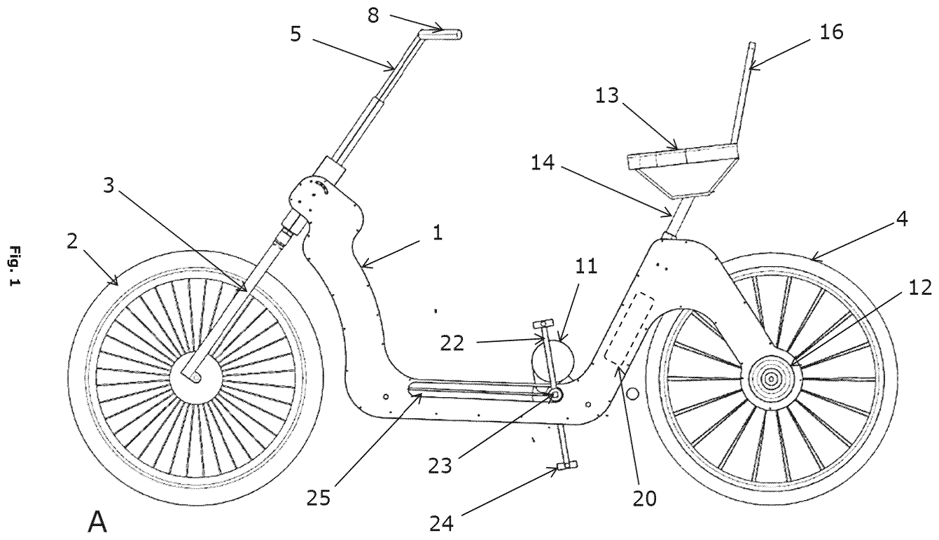

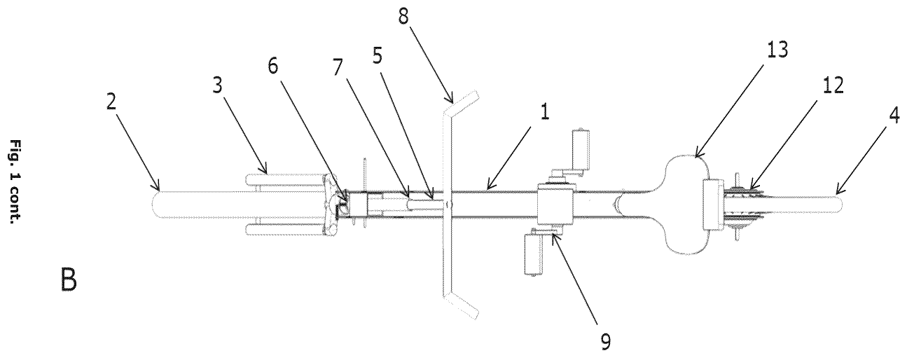

FIG. 1 discloses an electric bike according to one embodiment of the present invention. FIG. 1A shows a side view of the bike comprising a frame 1, a front wheel 2 attached to a fork 3 and a rear wheel 4 attached to the frame 1. A steering rod 5 is mounted in the frame 1 and connected to the front wheel fork 3, and a handlebar 8 is mounted on the steering rod 5. A pedal unit 9 is shown comprising two crank arms 22 rotating on axle 23 and pedals 24 on each crank arm 22. In the embodiment shown in FIG. 1 the pedal unit 9 is arranged in an elongated lateral slit 25 in the frame 1 for to be movably adjusted in different positions based on the needs of a cyclist. A generator 11 is associated with the pedals 9 in order to produce electricity as the pedals 24 are pushed to charge battery 20. The battery 20 is either arranged within the frame (indicated with a broken line) or mounted onto the frame (not shown). The rear wheel 4 is attached to the rear part of the frame 1 and a motor 12 is associated with the rear wheel 4 for powering the bike. A seat or saddle 13 is mounted onto a saddle rod 14 and in this embodiment the saddle 13 comprises a backrest 16 for individuals who need additional support on the bike. In FIG. 1B the same embodiment is shown in a top view.

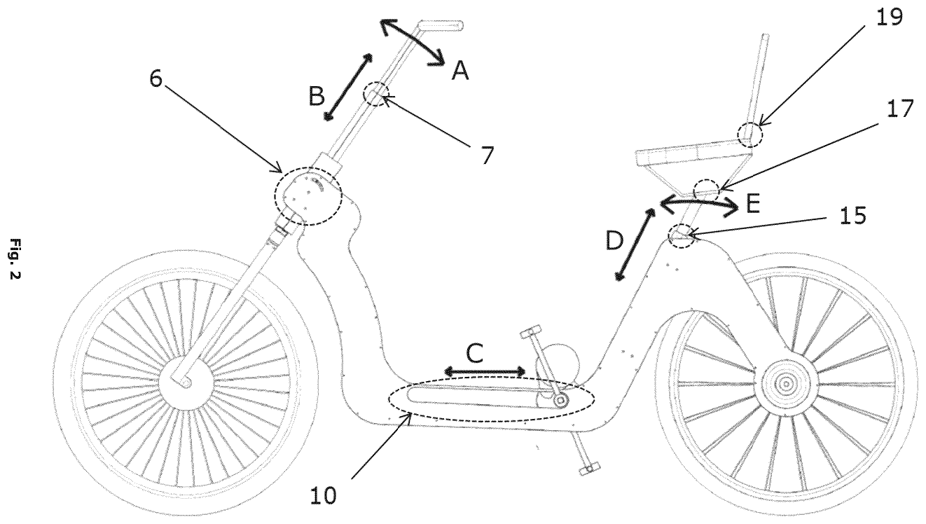

FIG. 2 shows a number of adjusting mechanisms on an electric bike according to the embodiment shown in FIG. 1. The adjusting mechanisms are indicated with dotted line circles for position in or on the frame and the arrows (A to E) indicate adjustment directions of the handlebar, the saddle and the pedal unit 9 and the generator in relation to the cyclist. An angle adjustment joint 6 is shown with the frame where the wheel fork 3 and the steering rod 5 come together. The angle adjustment joint 6 may be used to alter the angle of the steering rod 5, which alters the longitudinal position of the handlebar on the bike in relation to the cyclist. Therefore, the adjustment joint 6 allows adjustments of the steering rod and the handlebar in a diagonal backwards and forwards direction (the movement is indicated by arrow A). A steering rod adjustment mechanism 7 is also shown in the steering rod to adjust the height of the steering rod. Therefore, the height of the steering rod 5 from the ground can be set using the steering rod adjustment mechanism 7 (the movement is indicated by arrow B). In this embodiment the pedal unit adjusting mechanism 10 comprises an elongated slit in the frame and means for sliding pedal unit 9 back and forth in the slit between the front and back of the frame 1 (the movement is indicated by arrow C). There are number of means shown to alter the position of the saddle. A saddle rod adjustment mechanism 15 is shown for altering the height of the saddle from the ground or the lower part of the frame (the movement is indicated by arrow D). The saddle is mounted onto a saddle adjustment joint 17 on the saddle rod to provide a seesaw adjustment of the saddle on the saddle rod (indicated by arrow E). A backrest attachment joint (19) is also shown for altering the position of the backrest. Each of the adjusting mechanisms is arranged with means for operating the adjusting mechanisms to determine a position the various bike parts to determine a position of the pedal unit, the handlebar and the saddle to fit each cyclist for one or different phases of a bike ride.

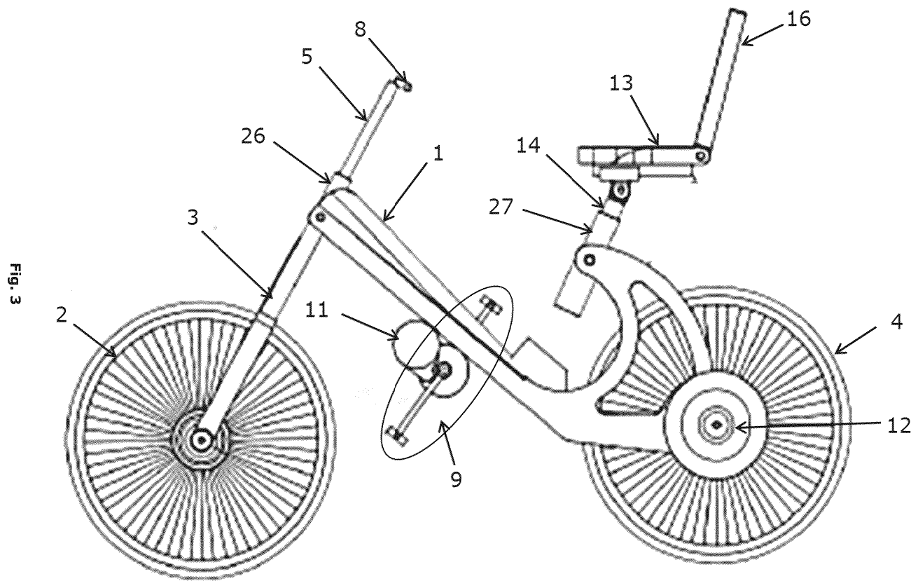

FIG. 3 shows another embodiment of an electric bike according to the present invention where the portion of the frame 1 extending between the front wheel 2 and the rear wheel 4 is diagonal tube or bar. A steering rod 5 is mounted in the head tube 26 of the frame 1 and a handlebar 8 is mounted on the steering rod 5. A pedal unit 9 has two crank arms with pedals rotating on axle and a generator 11 is associated with the pedals 9 to produce electricity when the pedal unit is being worked by the cyclist. The rear wheel 4 is associated with a motor 12 for powering the bike. The adjusting mechanism for the pedal unit 9 allows for a diagonal adjustment of the pedal unit between the front wheel 2 and the rear wheel 4. The bike in this embodiment has a similar saddle arrangement with a saddle 13 and a backrest 16, where the saddle is mounted onto a saddle rod 14. The saddle rod is arranged in the seat tube 27 where the seat tube is adjustably attached to the frame.

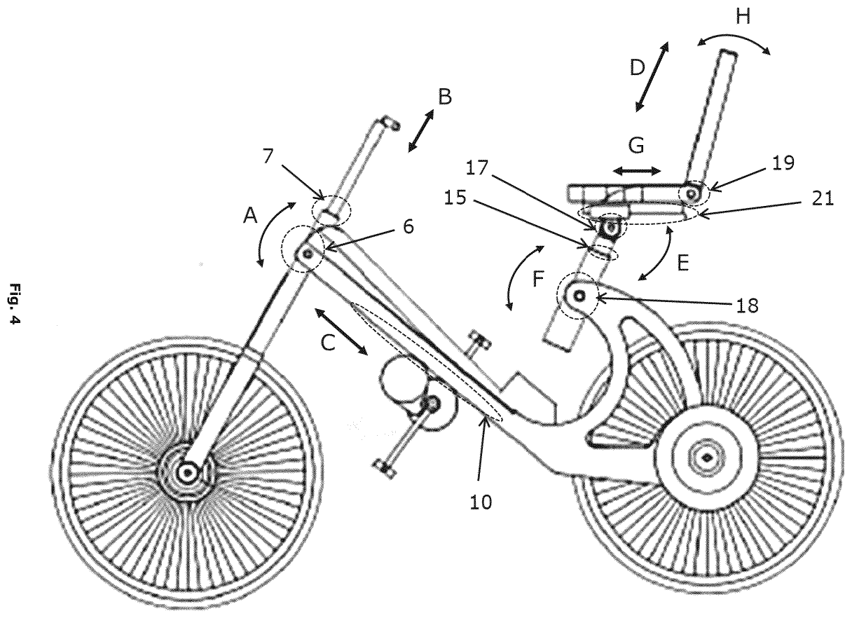

FIG. 4 shows several adjusting mechanisms on an electric bike according to the embodiment shown in FIG. 3. Each adjusting mechanism is indicated with dotted line circle for position in or on the frame and the arrows (A to H) indicate adjustment directions of handlebar, the saddle and the pedal unit in relation to the cyclist. The angle adjustment joint 6 is shown in the frame where the wheel fork and head tube come together. The angle adjustment joint 6 alters the angle of the steering rod 5 and thereby the longitudinal position of the handlebar on the bike in relation to the cyclist. Therefore, the adjustment joint 6 allows adjustments of the steering rod and the handlebar in a diagonal backwards and forwards direction (the movement is indicated by arrow A). The steering rod adjustment mechanism 7 alters the height of the handlebar 8 from the ground (the movement is indicated by arrow B). In this embodiment the adjusting mechanism for the pedal unit 9 and the generator is arranged on the exterior of the frame (the movement is indicated by arrow C). For this embodiment, there possibilities to adjust the saddle are increased as the seat tube 27 is adjustably attached to the frame. The saddle rod adjustment mechanism 15 alters the height of the saddle from the ground (the movement is indicated by arrow D), whereas the saddle adjustment joint 17 arranged on the seat rod provides a seesaw adjustment of the saddle on the saddle rod (indicated by arrow E). The attachment joint 18 for the saddle tube provides a diagonal movement in relation to the pedals and handlebar (the movement is indicated by arrow F). In the embodiment shown in FIG. 4 the saddle has an additional saddle sliding mechanism 21 for altering the longitudinal position of the saddle (the movement is indicated by arrow G). Furthermore, the saddle is shown with a backrest adjustment joint 19 between the saddle 13 and the backrest 16 for adjusting the backrest (indicated by arrow H). In the same way as described for FIG. 2 The one or more adjusting components of the bike indicated by arrows A-G can be associated with an adjusting mechanism for a manual, mechanical or electronic adjustment of the adjustable components of the bike. A backrest attachment joint (19) is also shown for altering the position of the backrest. Each of the adjusting mechanisms is arranged with means for operating the adjusting

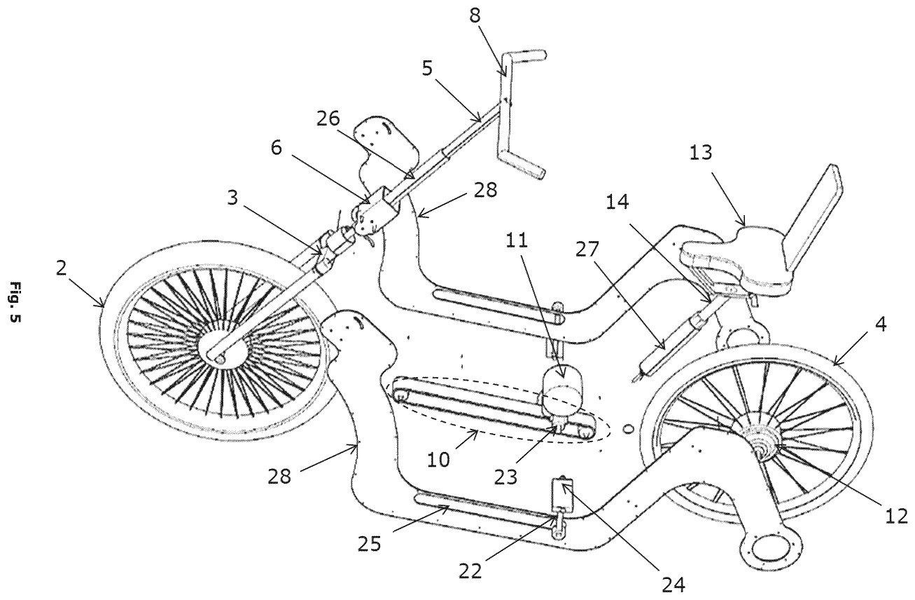

FIG. 5 demonstrates an assembly of an electric bike according to the embodiment shown in FIG. 1. The drawing is a perspective view of a bike where the frame is assembled from two profile plates 28, a head tube 26, an adjustment joint 6 and a seat tube 27. The bike further comprises a front wheel 2 attached to the fork 3 and a rear wheel 4 attached to the frame 1. The steering rod 5 is arranged in the head tube, which is connected to the front wheel fork 3 through the adjustment joint 6. The handlebar 8 is mounted on the steering rod 5 as well as pedal unit comprising two crank arms 22 rotating on axle 23 and pedals 24 on each crank arm 22. The generator 11 is associated with the pedal unit, which is arranged with the pedal unit adjusting mechanism 10 in an elongated lateral slit 25 in the profile plate 28 of the frame. The rear wheel 4 is attached to the rear part of the frame and a motor 12 is associated with the rear wheel 4 for powering the bike. The saddle 13 is mounted onto the saddle rod 14 which is arranged in the seat tube 27. The seat tube 27 is positioned in middle part of the frame between the two profile plates 28.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components.

The present invention also covers the exact terms, features, values and ranges etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the invention can be made while still falling within scope of the invention. Features disclosed in the specification, unless stated otherwise, can be replaced by alternative features serving the same, equivalent or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

1. An electric bike comprising:
a pedal unit,
a generator,
a motor, and
a battery,
wherein the pedal unit is connected to the generator to charge electricity to the battery, wherein the bike further comprises a pedal unit adjusting mechanism and wherein the pedal unit is movably arranged on or in the frame by the pedal unit adjusting mechanism to alter the longitudinal position of the pedal unit.

2. The electric bike according to claim 1, wherein the pedal unit adjusting mechanism comprises an elongated slit in the frame and means for sliding pedal unit back and forth in the slit between the front and back of the frame.

3. The electric bike according to claim 1, wherein the pedal unit adjusting mechanism comprises to alter the longitudinal position of the pedal unit on the exterior of the frame.

4. The electric bike according to claim 1, wherein the bike further comprises an angle adjustment joint in the frame to alter the angle of the steering rod.

5. The electric bike according to claim 1, wherein the bike further comprises a steering rod adjustment mechanism to adjust the length of the steering rod.

6. The electric bike according to claim 1, wherein the bike further comprises a saddle rod adjustment mechanism for altering the height of the saddle from the ground.

7. The electric bike according to claim 1, wherein the bike further comprises a saddle adjustment joint for seesaw adjustment of the saddle on the top of the saddle rod.

8. The electric bike according to claim 1, wherein the bike further comprises saddle rod attachment joint for altering the angle of the seat tube on the frame.

9. The electric bike according to claim 1, wherein the bike further comprises a backrest attachment joint.

10. The electric bike according to claim 1, wherein the bike further comprises a mechanism for adjusting the longitudinal position of the saddle.

11. The electric bike according to claim 1, wherein the electric bike comprises one or more of the following adjusting mechanisms:
the pedal unit adjusting mechanism,
the angle adjustment joint,
the steering rod adjustment mechanism,
the saddle rod adjustment mechanism,
the saddle adjustment joint,
the saddle rod attachment joint,
the backrest adjusting joint, and
the mechanism for adjusting the longitudinal position of the saddle,
wherein each of the one or more adjusting mechanism determine the position of one or more of the handlebar, the saddle, and the pedal unit for one or more moments of a bike ride.

12. The electric bike according to claim 11, wherein the one or more adjusting mechanism comprises a motorized adjusting mechanism.

13. A system for operating an electric bike, said electric bike comprising:
a pedal unit,
a generator,
a motor, and
a battery,
wherein the pedal unit is connected to the generator to charge electricity to the battery, wherein the bike further comprises a pedal unit adjusting mechanism and wherein the pedal unit is movably arranged on or in the frame by the pedal unit adjusting mechanism to alter the longitudinal position of the pedal unit,
wherein the electric bike further comprises one or more handlebar adjusting mechanism, and one or more saddle adjusting mechanism, wherein the position of one or more of the handlebar, the saddle, and the pedal unit may be adjusted before and/or during a bike ride.

14. The system according to claim 13 wherein the one or more adjusting mechanism is controlled by the cyclist through a leaver in the handlebar or on the frame.

15. The system according to claim 13 wherein the one or more adjusting mechanism is controlled by mechanical and/or electronic means to determine the position of one or more bike parts.

16. The system according to claim 15, wherein the system comprises a control unit and is operated through an application (APP) on a computing device or by the cyclist through leavers in the handlebar or on the frame.

17. The electric bike according to claim 15, wherein the control unit may be programmed to have stored in a memory more than one set of settings to determine the position of handlebar, the saddle, and the pedal unit for one or more users.

18. The electric bike according to claim 15, wherein the control unit may be programmed to have stored in a memory more than one set of settings to determine the position of handlebar, the saddle, and the pedal unit for one or more moments of a bike ride.
